(19) United States
(12) Patent Application Publication
(10) Pub. No.: US 2012/0143777 A1
(43) Pub. Date: Jun. 7, 2012

(54) USING DOCUMENTATION PLANS FOR SOA GOVERNANCE

(75) Inventors: Claus T. Jensen, Pawling, NY (US); Robert G. Laird, Colorado Springs, CO (US)

(73) Assignee: International Business Machines Corporation, Armonk, NY (US)

(21) Appl. No.: 12/962,331

(22) Filed: Dec. 7, 2010

(51) Int. Cl. G06Q 99/00

(52) U.S. Cl. 705/317

(57) ABSTRACT

A method, system, and computer program product for using documentation plans for service oriented architecture governance. In an example embodiment, the method includes implementing a structured documentation plan in a SOA governance tool using a computer processor. The structured documentation plan includes a set of documentation types and a set of governance policies for at least one documentation type from the set of documentation types.

### FIELD OF THE INVENTION

The present invention is directed to the field of computer systems, and more specifically to using documentation plans for SOA governance.

### BACKGROUND OF THE INVENTION

Service Oriented Architecture (SOA) is an architectural approach to designing systems across the business and IT boundaries. Current SOA governance planning practices take into account communication aspects, capturing communication policies in artifacts like a Communication Plan, yet do not extend the same level of formality to the planning and governance of documentation. In a Business Process Management (BPM) and/or Service Oriented Architecture (SOA) environment these challenges are compounded by the highly modeled and highly modularized nature of such solutions.

Current governance methodologies such as IBM's SOA Governance & Management Method (SGMM) do not include explicit policies for documentation—nor do current governance and modeling tools apply documentation policies to the verification and validation of foundation for an SOA solution.

### SUMMARY OF THE INVENTION

An example embodiment of the present invention is a method for maintaining documentation policies in a service oriented architecture (SOA) governance tool. The method includes implementing a structured documentation plan in a SOA governance tool using a computer processor. The structured documentation plan includes a set of documentation types and a set of governance policies for at least one documentation type from the set of documentation types.

A further embodiment of the present invention is a system for maintaining documentation policies in a SOA governance tool. The system includes a processor and a memory coupled to the processor. The memory has computer readable program code embodied in it. The computer readable program code is configured to implement a structured documentation plan in a SOA governance tool. The structured documentation plan includes a set of documentation types and a set of governance policies for at least one documentation type from the set of documentation types.

Another embodiment of the present invention is a computer program product for maintaining documentation policies in a SOA governance tool. The computer program product contains a computer readable storage medium having computer readable program code embodied in it. The computer readable program code is configured to implement a structured documentation plan in a SOA governance tool. The structured documentation plan includes a set of documentation types and a set of governance policies for at least one documentation type from the set of documentation types.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 is a flowchart illustrating an example method for maintaining documentation policies in a service oriented architecture (SOA) governance tool, as contemplated by the present invention.

FIG. 2 illustrates an example system for maintaining documentation policies in a SOA governance tool.

FIG. 3 illustrates the “define and enable” process for an example embodiment of the invention.

FIG. 4 is an example architecture overview for an example embodiment of the invention.

FIG. 5 is another example architectural overview diagram for an example embodiment of the invention.

FIG. 6 is a system context diagram of an example embodiment of the invention.

FIG. 7 is an example of a class diagram from an example embodiment of the invention.

FIG. 8 is a use case diagram of an example embodiment of the invention.

FIG. 9 is an example system use cases diagram for use in an example embodiment of the invention.

FIG. 10 is an example logical view design for the example embodiment of the invention.

FIG. 11 illustrates an example component logical view diagram for the example embodiment of the invention.

FIG. 12 is an interaction diagram for the example embodiment of the invention.

FIG. 13 is a diagram showing a logical topology for the example embodiment of the invention.

FIG. 14 is a diagram showing a communications topology for the example embodiment of the invention.

FIG. 15 is a diagram showing node descriptions in an example embodiment of the invention.

FIG. 16 is a diagram showing deployment unit to node mapping in an example embodiment of the invention.

FIG. 17 is a diagram showing deployment units to node mapping in an example embodiment of the invention.

FIG. 18 is an enterprise architecture table in an example embodiment of the invention.

FIG. 19 is a service dependency diagram in an example embodiment of the invention.

FIG. 20 is a service flow diagram in an example embodiment of the invention.

FIG. 21 is a flowchart of the SOA governance lifecycle in an example embodiment of the invention.

FIG. 22 is a generic outline for a control review in an example embodiment of the invention.

FIG. 23 illustrates the “handle and measure” process for an example embodiment of the invention.

### DETAILED DESCRIPTION OF THE INVENTION

Poor quality of documentation is one of the most common reasons for communication disconnects and ultimately software defects. Typically documentation is produced, if at all, in a manner that results in ambiguity among the multiple stakeholders.

From a governance perspective, the resulting problems are twofold: by not explicitly governing the creation and maintenance of documentation, the quality, consistency and completeness of services suffers across an enterprise. As a result of poor or unclear documentation, governance decisions that depend on that documentation are made inadequately or not made at all.

What can be done to overcome the challenges described is to enhance governance practices and tools by explicitly expressing documentation policies and tying these to the Service Oriented Architecture (SOA) and Business Process Management (BPM) governance processes of an enterprise. It is possible to document by planned choice, continuously and consistently in a monitored fashion, in order to enable proper governance decisions based on documented knowledge and in order to heighten overall service and documentation quality in the enterprise.

Aspects of the invention relate to maintaining documentation plans for SOA governance. Embodiments of the present invention model, capture and enforce documentation policies and practices in a documentation plan in order to standardize and optimize documentation within an effort or enterprise to the benefit of the SOA Governance and the quality of services. Further embodiments describe how to include in a documentation plan the following policies: what to document (and what not); where to document; in what format to document; in what granularity to document; in what structure to document; how to incorporate existing, non-standard, documentation; who is documenting which parts of the documentation (by role); how documentation is governed; and how documentation is maintained (and for how long). Further embodiments integrate the notion of a documentation plan as a key component in the SOA governance process, SOA governance tools and enforces the policies of the documentation plan in SOA modeling tools.

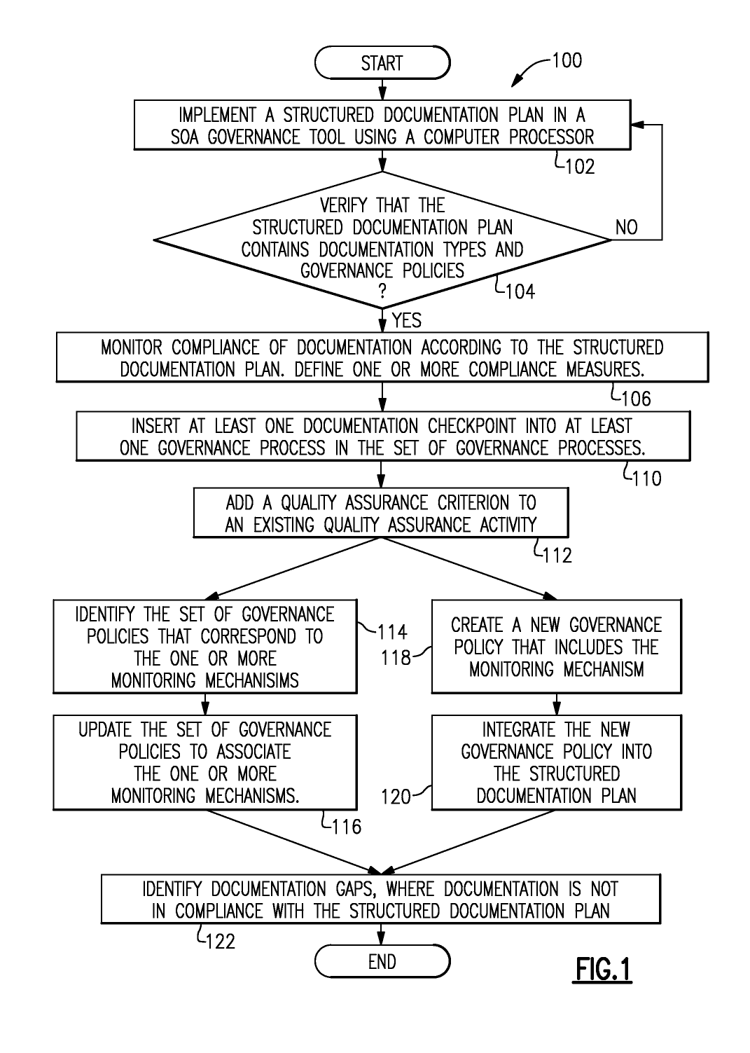

The present invention is described with reference to embodiments of the invention. Throughout the description of the invention reference is made to FIGS. 1-23.

FIG. 1 is a flowchart illustrating an example method 100 for maintaining documentation policies in a service oriented architecture (SOA) governance tool, as contemplated by the present invention. It is noted that the method 100 shown is just one example of various arrangements of the present invention and should not be interpreted as limiting the invention to any particular configuration.

An embodiment of the method for maintaining documentation policies in a SOA governance tool 100 may include implementing block 102 for implementing a structured documentation plan in a SOA governance tool using a computer processor. The structured documentation plan may include a set of documentation types and a set of governance policies that are in scope for the particular documentation type. To determine the documentation types used in the structured documentation plan, the scope of the structured documentation plan may be determined and utilized. The structured documentation plan may be defined by the documentation types in it. An embodiment of implementing the documentation plan, at block 102, may create a documentation plan in the form of documentation policies for each type of documentation that is in scope. Governance policies can include concrete rules, such as that a specific number of words to be documented, as well as broader principles such as documentation must define the business processes and services that are apart of the SOA solution.

Implementing a structured documentation plan, at block 102, may be further accomplished by defining the set of governance policies and recording the set of governance policies in the structured documentation plan. Governance policies may include specifying persons responsible for implementing or monitoring portions of the documentation plan.

A further embodiment of the method may include at least one documentation template within the structured documentation plan. The documentation template corresponds to a documentation type from the set of documentation types. The documentation templates and/or policies may specify a storage location for the documentation type; a document encoding for the documentation type; a list of persons responsible for the documentation type; a set of instructions to version the documentation type; and instructions to govern the documentation type. Documentation templates may include a specification of industry standards for documenting the documentation type. This includes recording best practices to define documentation policies and record the policies in the structured documentation plan. These documentation policies may then be codified in tools and infrastructure and the collection of data may be stored as a data type.

At verification block 104, the structured documentation plan may be assessed by verifying that the structured documentation plan contains documentation types and governance policies that cover all documentation used in SOA governance processes. A further embodiment may include verifying documentation is in compliance with documentation types and governance policies specified in the structured documentation plan by utilizing at least one metric. If all documentation types and governance policies needed for governance decisions are included in the structured documentation plan, then the method may proceed. Otherwise the structured documentation plan may be re-implemented, at block 102.

At monitoring block 106, measuring and monitoring mechanisms can be used to monitor compliance of documentation according to the structured documentation plan. In an embodiment of the invention, for each documentation type, one or more compliance measures are defined at monitoring block 106. Such compliance measures would typically be defined in advance of doing the monitoring. Compliance measures may be defined by using the structured documentation plan policies. Compliance measures may be based on compliance with documentation templates. Compliance measures may also be based on other defined criteria. These compliance measures can be codified in a form that is consumable by SOA governance tools and infrastructure as well as by SOA modeling tools. A further embodiment includes one or more monitoring mechanisms for each compliance measure. Compliance measures may be mapped to relevant components in the SOA governance system.

At defining block 110, monitoring mechanisms are defined as additional documentation checkpoints and may be enforced by lifecycles defined in the SOA governance system. These documentation checkpoints may be inserted into at least one governance process at defining block 110. The documentation checkpoint may specify a required approval to proceed with a service oriented architecture implementation. Checkpoints may also be enforced by lifecycles, which may be defined in the SOA governance system. In an embodiment of the invention, monitoring mechanisms are defined by adding a quality assurance (QA) criterion to an existing quality assurance activity at inserting block 112. QA criteria may use the compliance measure and may be linked to the governance processes enforced by the SOA governance system.

Embodiments of the invention include embedding mechanisms in governance processes. This may include deploying associated policies to the component of the SOA governance system that implements the monitoring mechanism. This may include identifying the governance policies that correspond to the monitoring mechanisms at identifying block 114, and updating the governance policies to associate the monitoring mechanisms at updating block 116. Another embodiment of the invention may include creating a new governance policy that includes the monitoring mechanism at creating block 118, and integrating the new governance policy into the structured documentation plan at integrating block 120.

With monitoring mechanisms created, the method for maintaining documentation in a SOA governance tool may include identifying documentation gaps, where documentation is not in compliance with the structured documentation plan at identifying block 122. This may include the steps of: identifying, using the structured documentation plan, at least one documentation type that is in non-compliance; identifying which governance policies are not complied with for each documentation type; identifying at least one party responsible for managing the documentation type; and generating a notification to the party responsible for managing the documentation type. The party responsible for managing a particular documentation type may be in the field “who should document” in the structured documentation plan or related data structure. The notification generated may include relevant data about any non-compliance issues as well as policies that were not complied with.

When non-compliance issues are identified, they may be corrected. For each documentation type, documentation may be corrected to be in compliance with the policies listed in the notification. Once corrected, it can be reported back to the SOA governance system that the non-compliance issue has been resolved. The SOA governance system may then verify that the non-compliance issue has been resolved. The non-compliance issue may then be registered as closed and normal monitoring operation resumes.

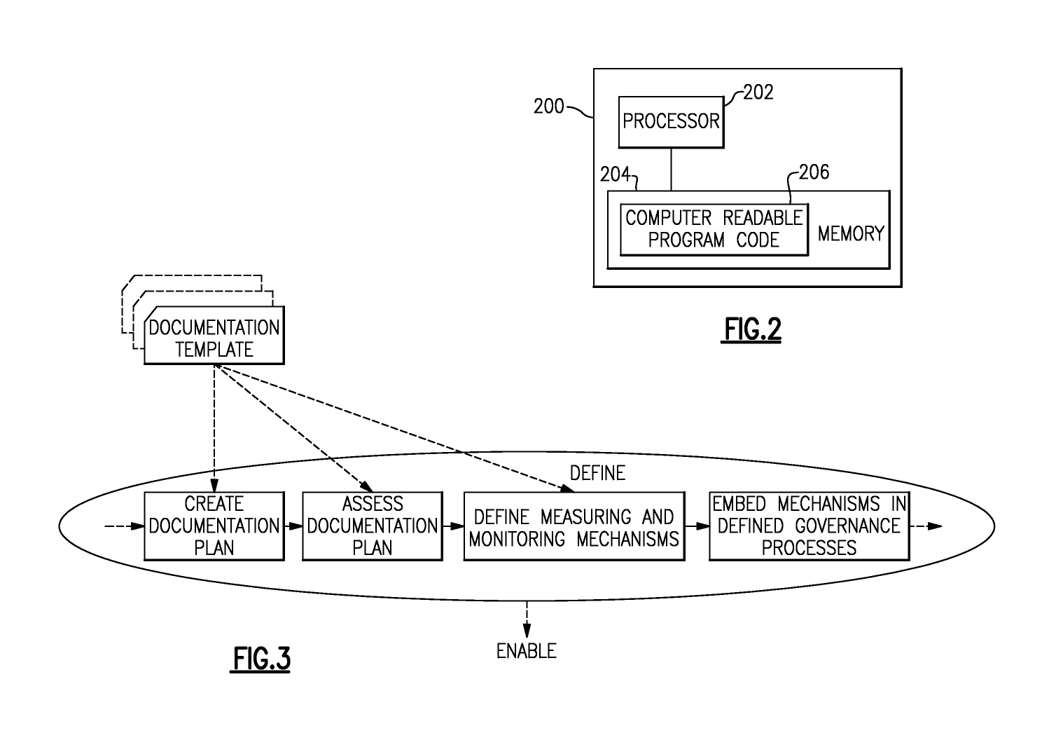

FIG. 2 illustrates an example system for maintaining documentation policies in a SOA governance tool 200. The system may include a processor 202 and memory 204 coupled to the processor. The memory 204 includes computer readable program code 206 embodied on it. The computer readable program code 206 may be configured to implement a structured documentation plan in a SOA governance tool. The structured documentation plan may include a set of documentation types and a set of governance policies for at least one documentation type. In another embodiment of the invention the computer readable program code 206 is configured to monitor compliance of documentation according to the structured documentation plan.

### Example Embodiment of the Invention

The follow examples are presented for illustration purposes only, and are representative of countless system configurations in which the invention may be implemented. Thus, the present invention should not be considered limited to the configurations shown and discussed herein.

FIG. 3 illustrates the “define and enable” process for an example embodiment of the invention. For the purposes of this example, two templates are shown that the SOA governance function has created in response to a need to build quality services.

Solution Architecture Document. This is analogous to the documentation template for a complete solution. The purpose of the Solution Architecture Document is to provide a comprehensive overview of the architecture of the software system. It serves as a communication medium between the solution architect and the project team members regarding architecturally significant aspects of the proposed solution. A potential format for this document is in Microsoft® Word. The Solution Architecture Document is a documentation template for a complete solution. It may contain documentation templates for various components in the solution. These may include:

Document Purpose. This section defines the role or purpose of the Software Architecture Document, in the overall project documentation, and briefly describes the structure of the document. The specific audience for the document may be identified, with an indication of how they are expected to use the document. This document provides a comprehensive architectural overview of the system, using a number of different architectural views to depict different aspects of the system. It is intended to capture and convey the significant architectural decisions that have been made on the system.

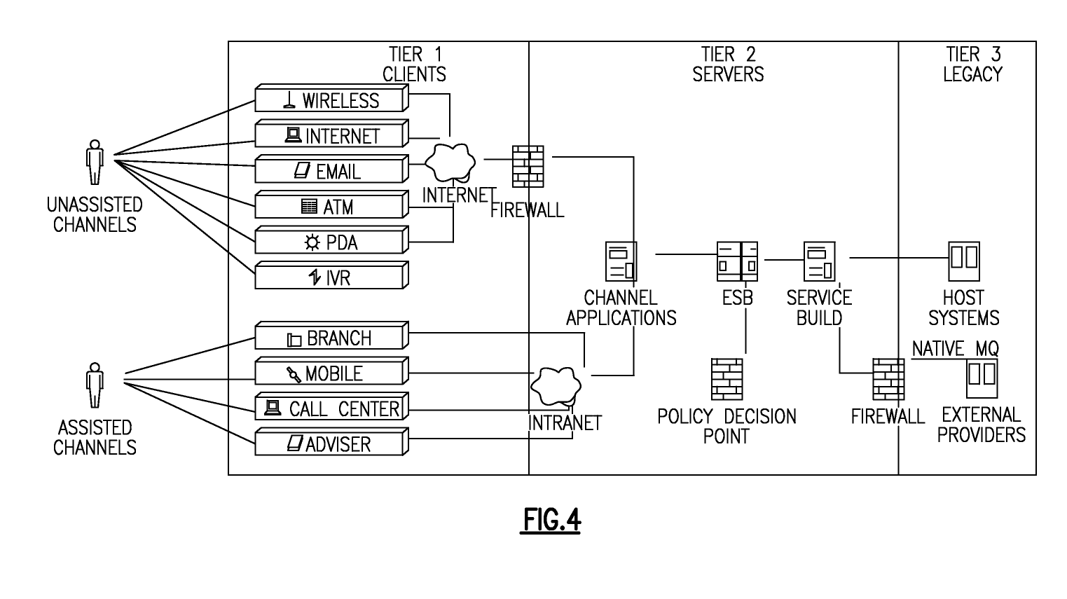

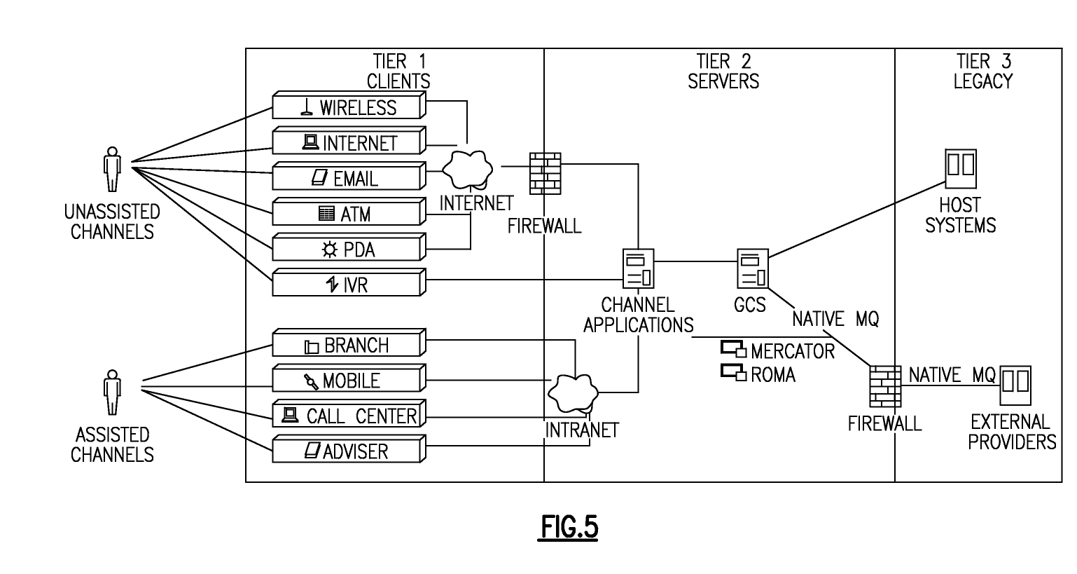

Context of Solution. This section can provide a brief description of the project background and purpose of the solution. An Architectural Overview diagram may be included to communicate the main conceptual elements in the solution. FIG. 4 is an example architecture overview for an example embodiment of the invention. A diagram may also be used to highlight the scope of the solution.

Architectural Goals and Constraints. This section may describe the software requirements and objectives that have some significant impact on the architecture, for example, safety, security, privacy, use of an off-the-shelf product, portability, distribution, and reuse. It also captures the special constraints that might apply: design and implementation strategy, development tools, team structure, schedule, legacy code, and so on. This document may mention reference architectures applicable for this solution. The template may include language such as: “The project will be developed according to the reference architecture for enterprise applications. Specifically: The project will . . . . The application will . . . ” Appropriate information and paragraphs may be added as required to capture any goals and constraints of the architecture.

Current State. This section provides a brief description of the current state architecture. FIG. 5 is an example architectural overview diagram that may be included to communicate the main conceptual elements in the current state for an example embodiment of the invention.

Architectural Goals. Language may be included in the document to discuss architectural goals such as: “The following goals have been identified for this architecture: . . . .” Here, all goals could be added for the architecture.

Scope. This section may include a brief description of what the Software Architecture Document applies to and what is affected or influenced by this document.

In Scope. This is a section that may be completed if it shows any major architectural direction arising out of the inclusion of a problematic or optional feature or feature that currently does not seem to be relevant. A table describing the scope item and the impact can be used to detail items that are within the scope.

Out of Scope. This is a section that may be completed if a requirement that would have had a major effect on the solution architecture has been ruled out because of factors such as price, skills, project time constraints, inadequate existing technology, inadequate infrastructure, or other factors. A table describing the scope item and the impact can be used to document which features are outside the scope.

Assumptions. This is an optional section that may be used to describe what assumptions either implicit or explicit are being made which directly affects the Architecture. Questions such as “what assumptions could constitute a risk from Architectural point of view?” may be answered. Example language that can be used includes: “The following architecture assumptions have been identified during the scoping exercise:.” This could be followed by a list of all assumptions for the architecture.

Constraints. This is an optional section that may be used to describe what constraints exist which has a direct impact on the architecture. These constraints could be technical, infrastructure, geographic or business related. These constraints have made the resulting architecture less than optimal. Example language that can be used includes: “The following constraints are valid for this architecture: . . . .” This could be followed by a list of all constraints for the architecture.

Issues & Risks. This is an optional section that may be used to describe any issues and risks arising or may arise from the solution or by trying to implement the solution. This section should focus on the aspects of the solution architecture, which may not fulfill the requirements once the solution is live, rather than include project issues and risks. These issues may include a change in structure, a change in technology (e.g., obsolescence, changes in locations, vendor/platform issues and risks, and compliance issues and risks). Example language that can be used includes: “The following issues and risks are valid for this architecture-” This could be followed by a list of all issues and risks for the architecture.

Requirements Viewpoint. The requirements view is concerned with the specification of the requirements, which influence the ultimate solution. This section may present the architecture as a series of views, including use-case and logical views. These views may be presented using the Unified Modeling Language (UML).

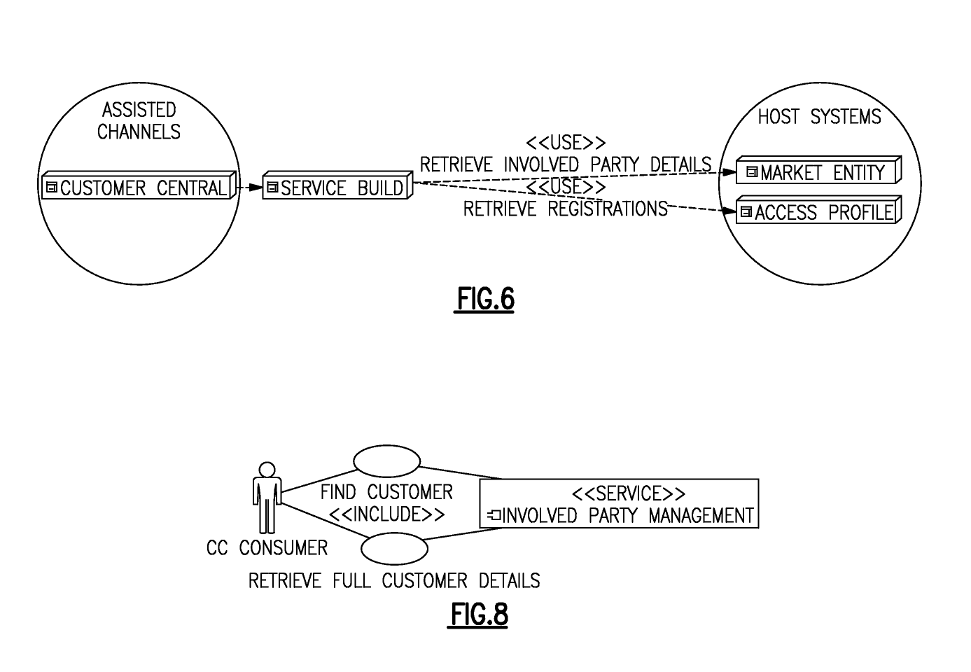

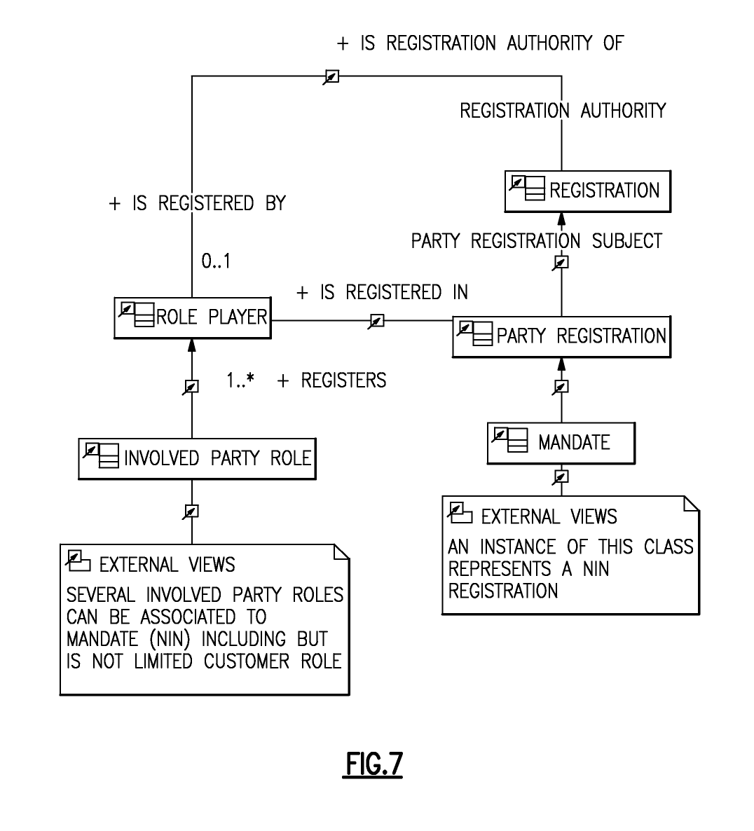

System Context. This section may include a system context diagram to highlight the scope of the solution and boundaries of the solution. FIG. 6 is a system context diagram of an example embodiment of the invention. The context diagram shows the entire system represented as a single object or process, and identifies its interfaces with external entities of the system. A system context table could also be used to list entities and descriptions.

Component Business Model. A Component Business Model (CBM) map may be used to highlight the functional area that has been scoped as core to the project.

Domain View. This section describes the key entities in scope for this solution. FIG. 7 is an example of a class diagram from an example embodiment of the invention. A class table can be constructed with fields for the class and a description. A class diagram and table may be used to describe key entities.

Process Model. This is an optional section that may be used to provide a list of the processes that are in scope for this project release.

Use Case View. This section describes use cases or scenarios from the use-case model if they represent some significant, central functionality of the final system, or if they have a large architectural coverage, they exercise many architectural elements, or if they stress or illustrate a specific, delicate point of the architecture. The use case view may show an architecturally significant subset of the use case model, a subset of use cases and actors.

Business Use Cases. The business use cases in scope for a project release may be shown on a use case diagram. The inclusion relationships between these use cases can also be indicated. FIG. 8 is a use case diagram of an example embodiment of the invention. Example language describing this use case diagram may be: “The following use case diagram is an initial view of the system's functionality scope based on the Business Requirements documentation and discussions with the business.” An actor descriptions table can be used to record different actors that may use the underlying product and their descriptions. Subsections may be added to capture all the use cases in the architecture.

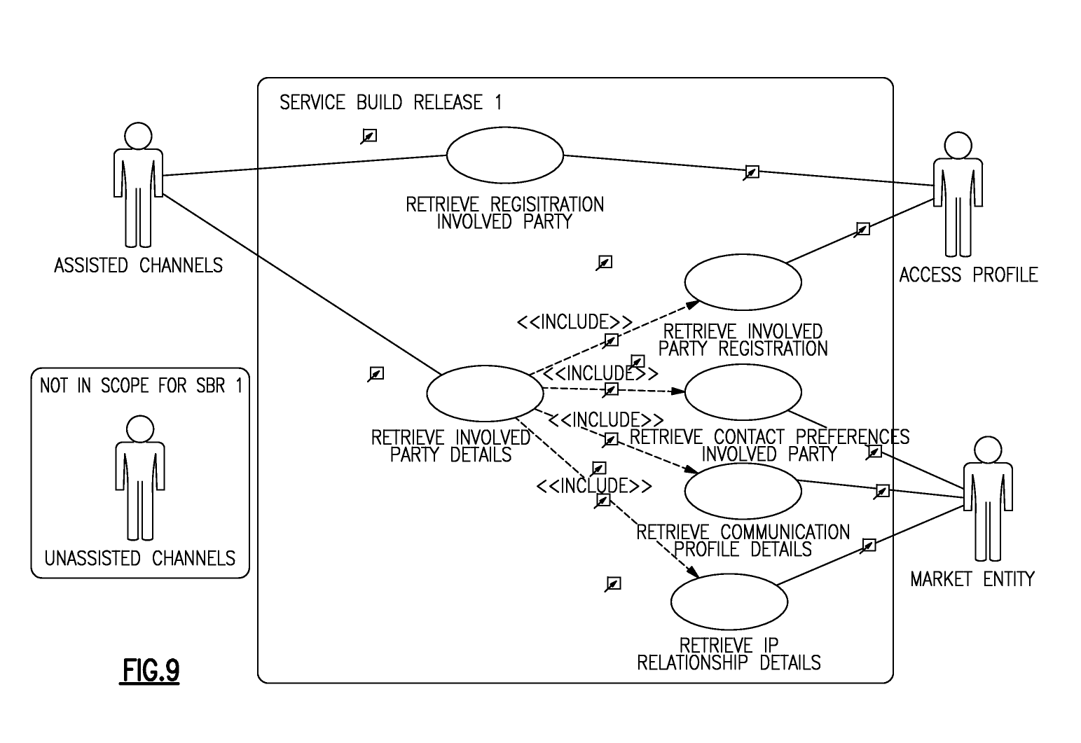

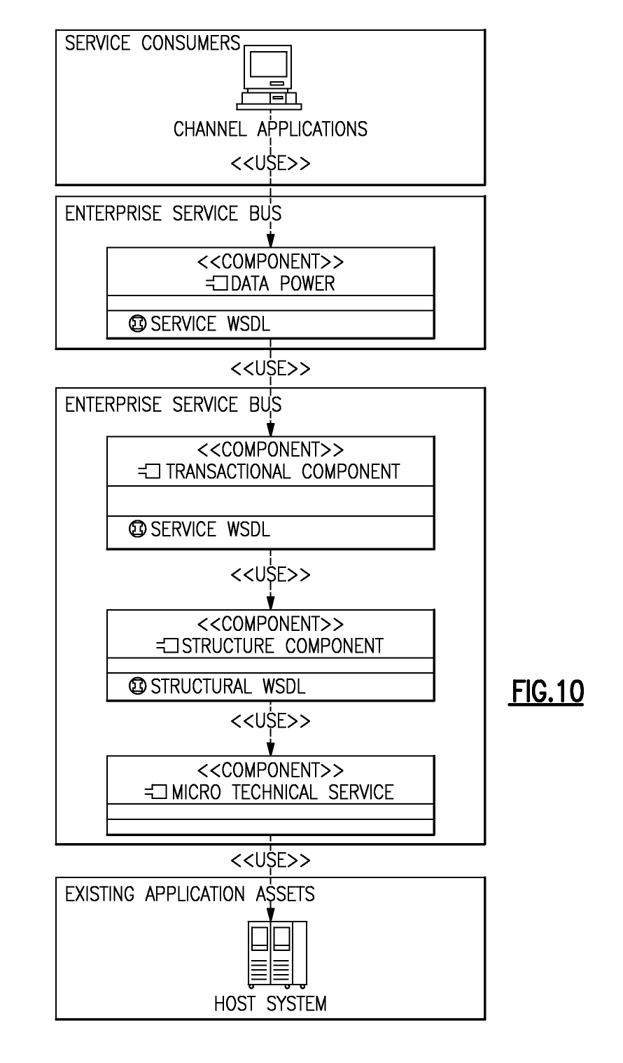

System Use Cases. The system level use cases in scope for a project release should be shown on a use case diagram. The inclusion relationships between these use cases can also be indicated. FIG. 9 is an example system use cases diagram for use in an example embodiment of the invention. The system use case may highlight the system use cases, which describe the services to be provided by the solution. Like the use case diagram in FIG. 8, an actor descriptions table may accompany the system use case diagram in FIG. 9 with fields for the actor and a description. Additionally, a list can be added to capture all the use case cases in the architecture.

Non-Functional Requirements View. This section may describe how any architecturally significant non-functional requirements can be addressed by the solution. The non-functional requirements may be sourced from a Supplementary Specification document. Areas to consider may include: usability, reliability, performance, supportability, disaster recovery, and security. The disaster recovery solution can be reflective of the nature of the system. Considerations may include: speed to recovery, characteristics of the system, and risk criticality. That is, in an online real-time system (e.g. internet banking), consideration may be given to an active-active failover scenario to supplement or supersede disaster recovery. Reference may be made to a Supplementary Specification document for a description of the non-functional requirements in scope for this project release.

Compliance Requirements View. For projects that are impacted by compliance requirements, the specific legislation and its impact may be described. This could include Sarbanes-Oxley requirements. For Sarbanes-Oxley, the business may advise if the application is affected by this act.

Design Viewpoint. This section may describe the architecturally significant parts of the design model, such as its decomposition into subsystems and packages. For each significant package a policy may include describing its decomposition into classes and class utilities, including descriptions of their responsibilities, important relationships, operations, and attributes. Reference may be made to the relevant Service Specification and Service Component Specification.

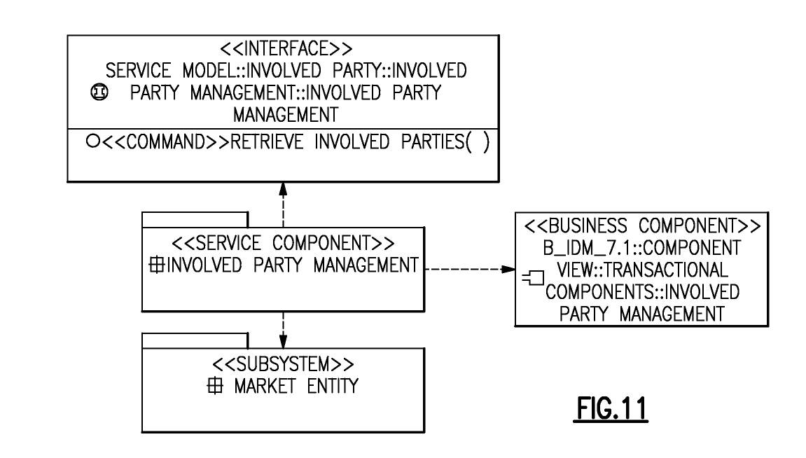

Logical View. This section can provide an overview of the solution from a logical design perspective. FIG. 10 is an example logical view design for the example embodiment of the invention.

Component View. FIG. 11 illustrates an example component logical view diagram for the example embodiment of the invention. This section can describe the major solution components and their related IFW components. This section may highlight the relationships between the solution components and subsystems like channels and host systems. Some examples of subsystems include: reference data maintenance, communications, printing, transactional management, functional partitioning along business process lines (care may be taken here as businesses restructure), functional processing if workflow is involved and one business process can be isolated into a subsystem, role based functionality, process based partitioning e.g. batch vs. online or transactional vs. informational, and the security subsystem. A diagram as in FIG. 11 may illustrate the component view and elements may be described in the element description table as well. The columns in the table can be elements and descriptions.

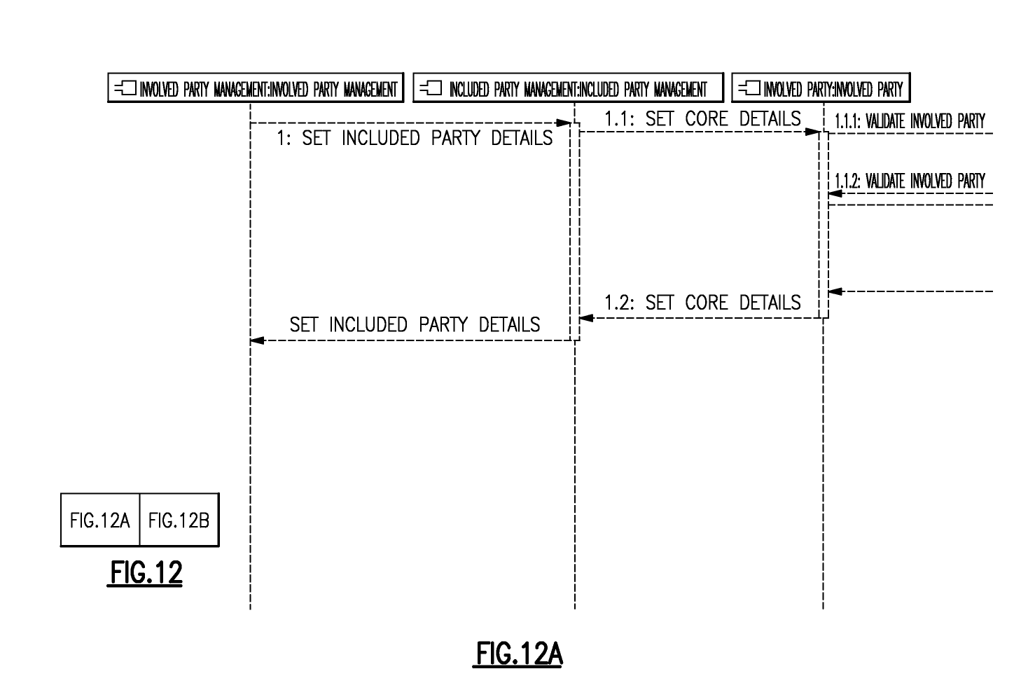

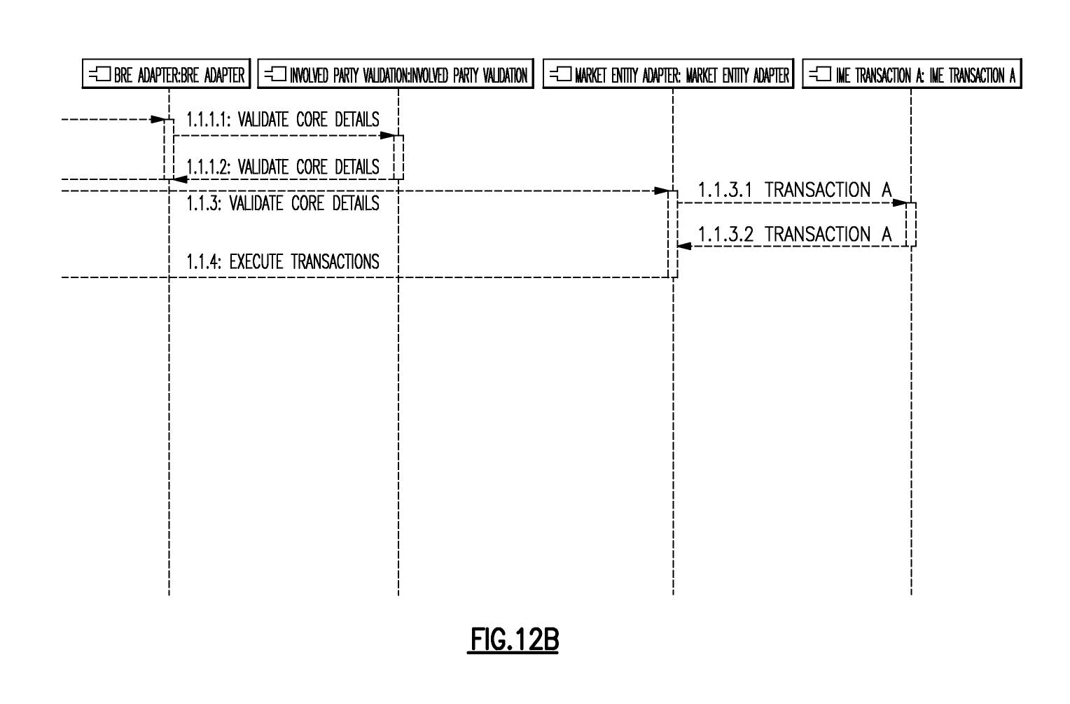

Component Dynamic View. This section describes the major solution components interactions using Unified Modeling Language (UML) interaction diagrams. FIG. 12 is an interaction diagram for the example embodiment of the invention. An interaction diagram can be used to illustrate the main flow of each business use case and optionally any significant exception flows.

Non-Functional Requirements View. This section may describe how any architecturally significant non-functional requirements will be addressed by the solution. The non-functional requirements can be sourced from a Supplementary Specification document. Areas to consider include: usability, reliability, performance, supportability, security, and disaster recovery. The disaster recovery solution may be reflective of the nature of the system. Considerations may include: speed to recovery, characteristics of the system, and risk criticality. That is, for an online real-time system, e.g. internet banking, consideration can be given to an active-active failover scenario to supplement or supersede disaster recovery.

Realization Viewpoint, Implementation View. This section may describe the topology and geographic distribution of the system, the definition of the nodes (computer platforms) and network connections, and where and how users and external systems interact with the system.

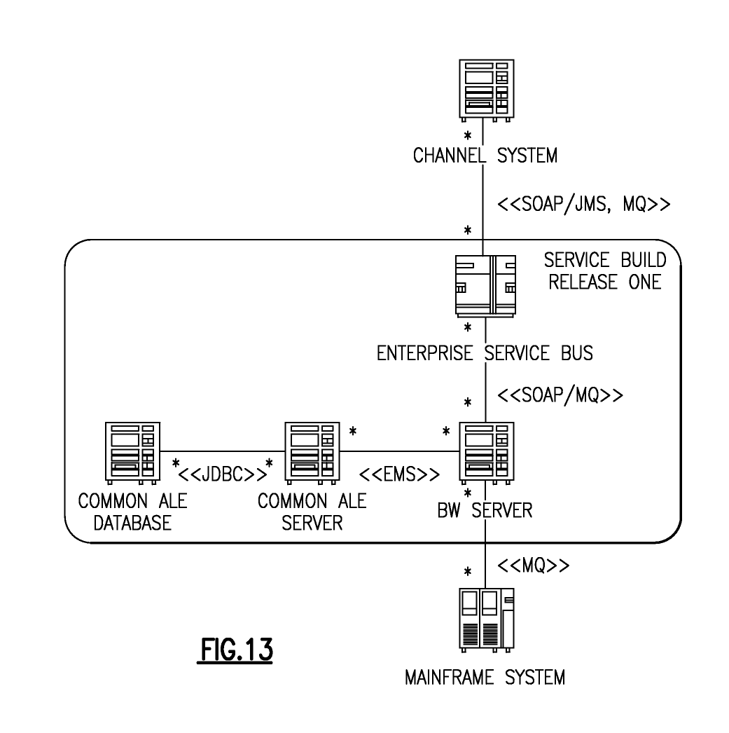

Logical Topology. FIG. 13 is a diagram showing a logical topology for the example embodiment of the invention. This section can describe the logical structure of the solution topology. This section can be used to highlight the scope of the solution. This section may be illustrated with a diagram like that in FIG. 13.

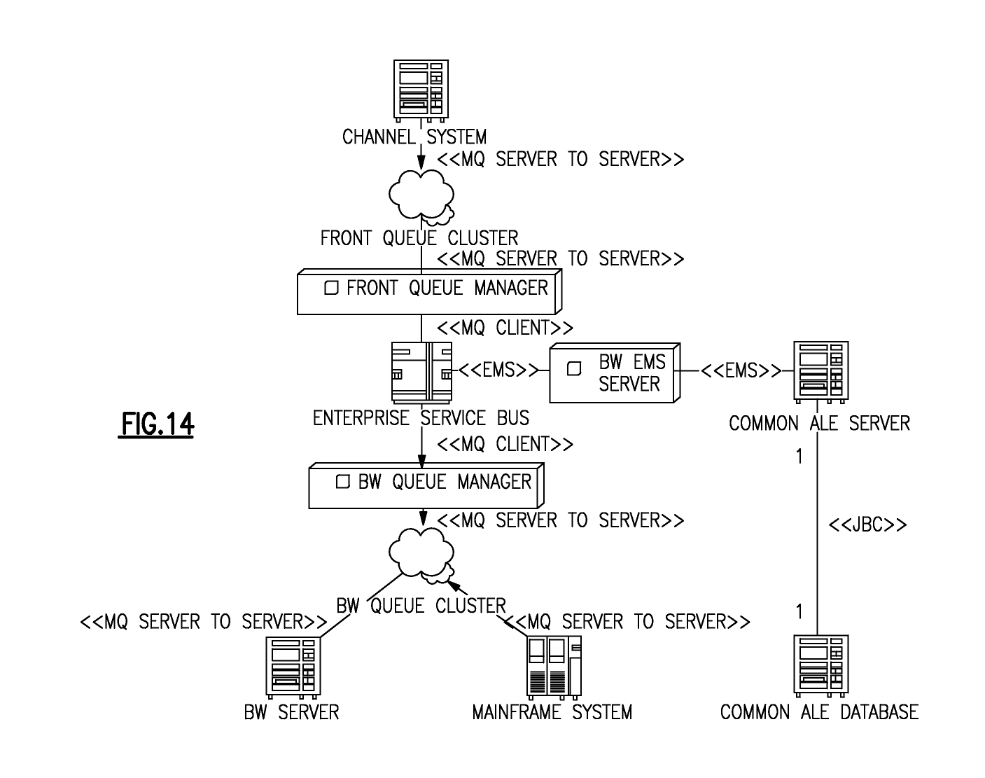

Communications Topology. FIG. 14 is a diagram showing a communications topology for the example embodiment of the invention. This section may describe the how the various logical nodes in the solution communicate, indicating transport protocols. This section may be illustrated with a diagram like that in FIG. 14.

Geographical Topology. This is an optional section that may be completed to describe the relationship between the logical nodes in terms of their geographical location or zone. Considerations like disaster recovery may be illustrated.

Deployment View. In this section reference may be made to a Technology Operations Infrastructure High Level Design document for details of physical node specifications and configuration.

Node Descriptions. FIG. 15 is a diagram showing node descriptions in an example embodiment of the invention. A node descriptions table can be used with two columns for the node and a description of it. For instance, each of the nodes in FIG. 15 may be rows in the table. There would be a row for each node: Channel System, BW Queue Cluster, BW Queue Manager, BW Server, Enterprise Service Bus, Front Queue Cluster, Front Queue Manager, and Mainframe System. Beside each node there would be an area to describe it. The node descriptions section describes in detail each node and identifies and classifies the software components that run on the node. This section may be illustrated with a diagram as in FIG. 15 or a node descriptions table as described.

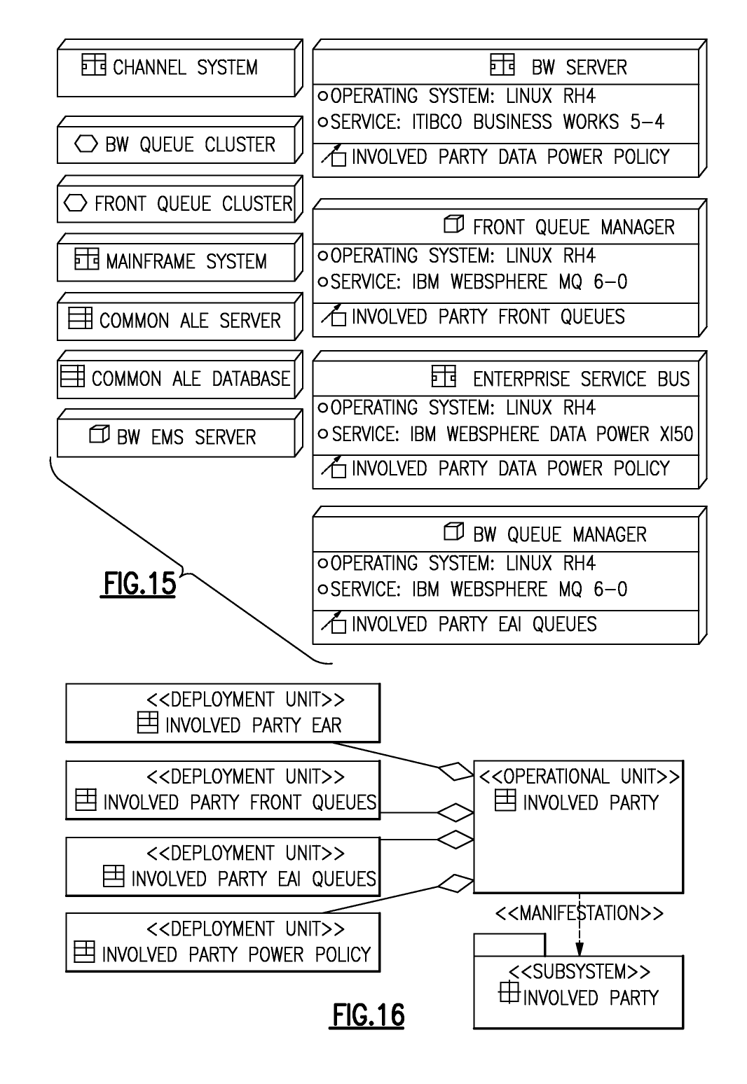

Deployment Units. FIG. 16 is a diagram showing deployment unit to node mapping in an example embodiment of the invention. An artifact description table can be created as shown in Table 1 below. This section may describe the deployment units that realize each subsystem. A deployment unit is a convenient grouping of components from the software architecture. This section may be elucidated with a diagram and table as in FIG. 16 and example Table 1.

TABLE 1

| Artifact | Description |
|---|---|
| Involved Party | EAR file containing Involved Party |
| EAR | Transactional and Structural components |
| | for Involved Party domain |
| Involved Party | |
| Front Queues | |
| Involved Party | |
| EAI Queues | |
| Involved Party | |
| DataPower Policy | |
| Involved Party | The effective unit of work to fully deploy |
| | the Involved Party subsystem |

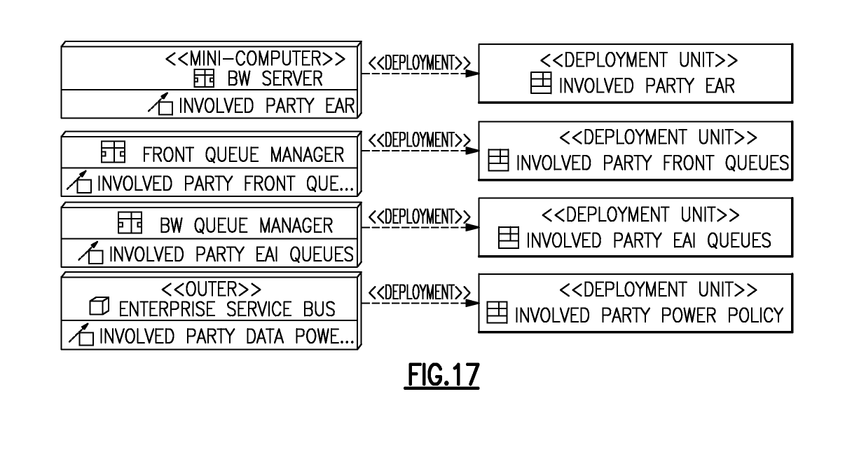

Node—Deployment Unit Mapping. FIG. 17 is a diagram showing deployment units to node mapping in an example embodiment of the invention. This section may describe the mapping between nodes and deployment units. A table may be used to show the relationship between the node and deployment unit. The columns of the table can be node and deployment unit. For instance, as shown in FIG. 17, a row in the table can include the information “BusinessWorks Server”, under “Node”, and “Involved Party EAR” under “Deployment Unit”.

Network Usage. This section may describe the network components of the implementation model. Possible questions that should be answered in this section include: what are the network boundaries?; does the solution need to communicate with external parties?; what mechanism does it use?; are there any special considerations for interfacing with other systems, e.g. code translation?; describe any special communication protocols used in the solution for access and data transfer; what is the expectation of network bandwidth between application server and client interface?; does the solution require any special firewall configuration?; are there any expected peak volumes and peak times?; what is the typical end user response time?; and does the solution require support for WAN printing?

Security. This section may refer to a Security Solution Architecture Document.

Migration Plan. Solutions and questions discussed in this section may include: providing a high-level migration plan where necessary if the solution requires data from exiting systems; providing a high level change plan if new technology is being introduced in the organization; providing details on how reference data will be populated in the solution; how will the solution be populated from existing systems, from independent data sources and data capture processes?; what facilities are available to archive old information, and whether archived information is easily accessible to users; what features are provided for importing information into the proposed solution (e.g. importing information from pre-existing applications.)?; would migration of this information be automated or manual?; what features (e.g., reconciliation) are provided to ensure the quality of data being imported into the proposed solution?; how will existing interfaces be handled?; how can the data formats of any systems that are replaced be phased out?; is adequate training and support in place for the new solution?; have the operational support personnel been informed of the new solution?; and describe the release versioning strategy including services to be deprecated or decommissioned.

Architectural Decisions. This section may document important decisions about any aspect of the architecture including the structure of the system, the provision and allocation of function, and the contextual fitness of the system and adherence to standards. An architecture may be understood partly through the record of the important decisions made during its development. A well-documented architecture may include its own justification and evaluation criteria. The justification and evaluation criteria may be recorded alongside the decision or, at least in part, by reference to more generally applicable principles, policies and guidelines, which are found in other work products or in external references. Table 2 is an example decisions table. A table similar to Table 2 can be completed for each significant architectural decision.

TABLE 2

| | | | |
|---|---|---|---|
| Subject Area | Area of Concern | Topic | Topic of |
| | | | Interest |
| Architectural | | AD ID | A unique |
| Decision | | | identifier |

| | |
|---|---|
| Issue or | A short description of the problem-what is |
| Problem | being decided |
| Assumptions | What is believed to be true about the |
| | context of the problem, constraints on the |
| | solution |
| Motivation | Why this decision is important |
| Alternatives | A list of alternatives and explanations |
| Decision | The decision taken, possibly with |
| | references to related work products |
| Justification | Why the decision was made and a list of |
| | compliance to Architecture Principles and |
| | explanations of deviations from compliance |
| Implications | What impact the decision will have |
| Derived | A list of requirements that are generated |
| requirements | by this decision |
| Related | A list of related decisions |
| Decisions | |

Assessment of Solution Architecture. The solution architecture may be subject to these reviews before it can be approved.

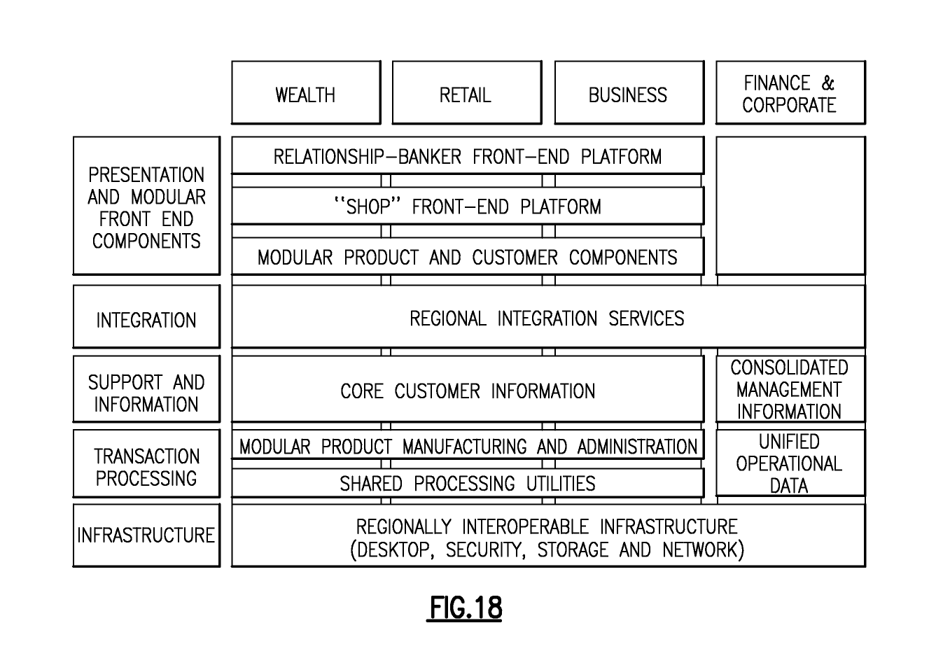

Alignment to Enterprise Architecture. FIG. 18 is an enterprise architecture table in an example embodiment of the invention. Areas of impact may be highlighted on the diagram.

Alignment to Architecture Principles. Principals include usability, re-use, business agility, modularity and layering, and industry standards. This can be documented in a table form with principle and comment as columns and each of the aforementioned principals as rows. Comments could be filled in to describe each principal and how it relates to the architecture.

Exceptions. This section may include details of any exceptions applied for as they apply to the architecture or components. These exceptions may be documented in a table with columns for exception requested, rationale, impact, and approved by. Details of any plans to remediate the exceptions applied for may be included in a table with columns for: exception requested, remediation plan, target date, and approved by.

Service Specification Template. The purpose of the Service Specification document may be to detail the functionality provided by the service from a service consumer perspective. The Service Specification can define the dependencies, composition, messages, quality of service constraints, and state management and realization decisions for the service. The Service Specification may describe the service so that it can be understood by both the service developers and by consumers of the services. The format can be in Microsoft® Word or in a modeling tool. A service description table may be used to include information such as the service name, service version number, service description and value, user communities that will use the service, and processes that use the service.

Service Dependencies. FIG. 19 is a service dependency diagram in an example embodiment of the invention. Service dependencies may describe the relationships between services that arise in the larger context of how they will be used. Functional Dependency (Composite Service) may occur when a service is formed from a composition of other services. Temporal Dependency may occur when there is a process related dependency. This may arise when services are used in the context of a business process, and there is some dependency that arises from the sequence of steps in the business process that dictates the order in which services will be used. The resulting dependencies may be: pre-condition dependency, another service invocation must have executed successfully before the current invocation can begin execution; processing dependency, another service invocation is required to complete the successful execution of the current service; or post-condition dependency, where a service requires another service invocation after its execution. Dependencies may be represented visually with accompanying text that describes the nature of the dependencies. For functional dependencies, a UML component relationship diagram can also be used. For processing dependencies a UML sequence diagram may be used.

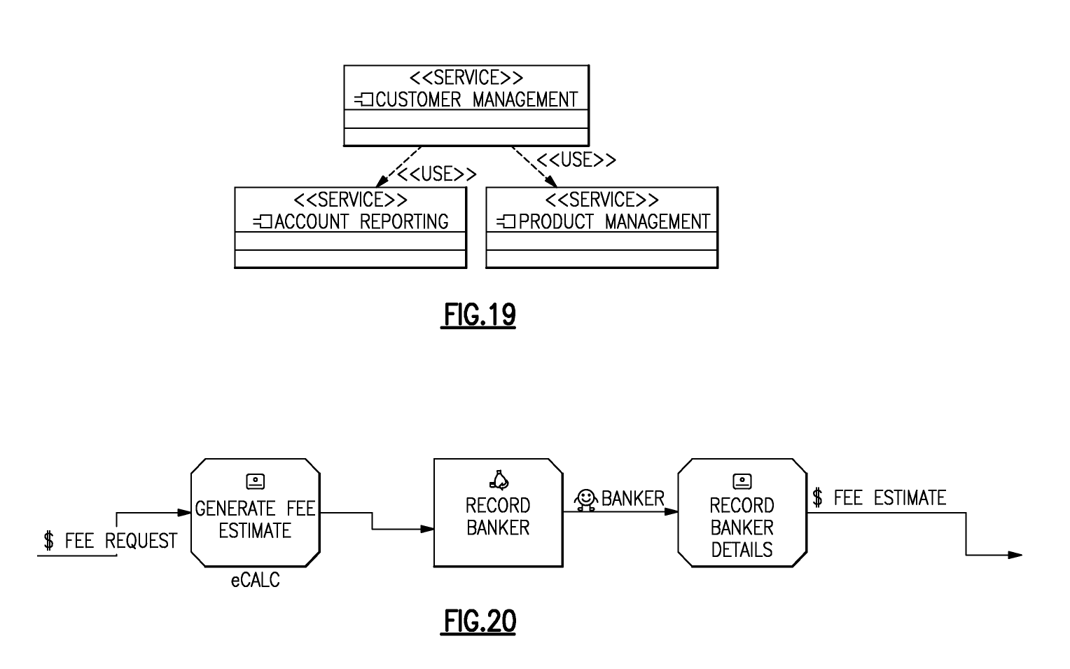

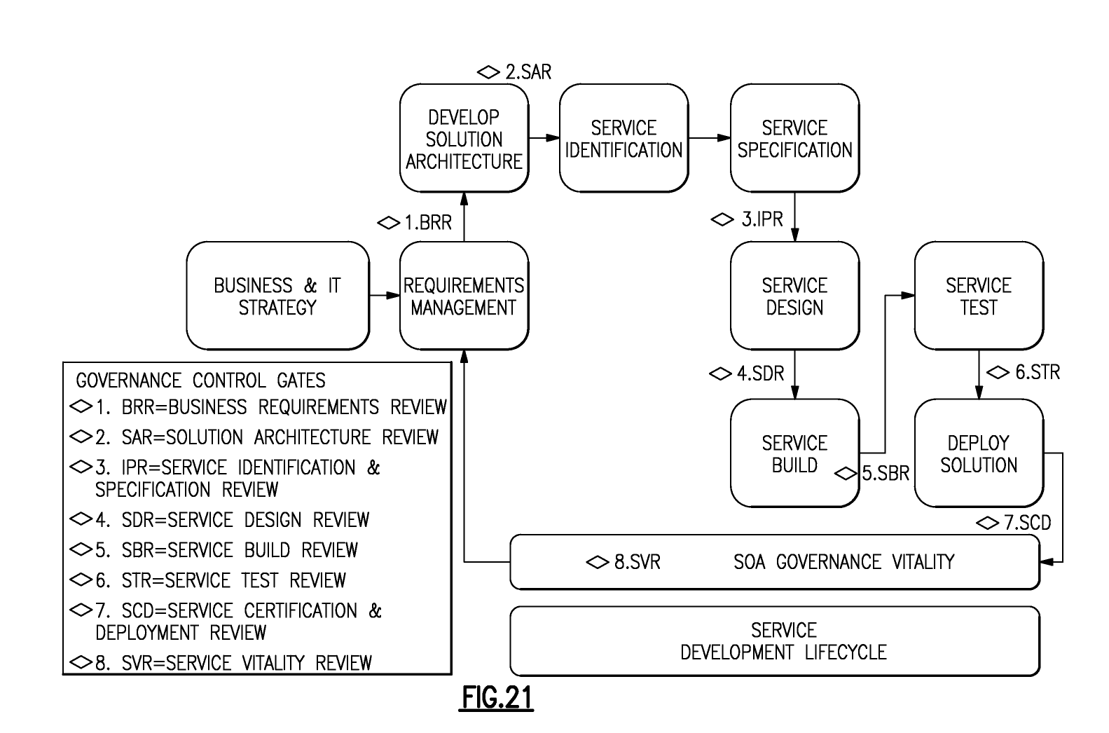

Service Composition and Flow. This optional section may only be required for composite services, where the service is composed of other services. The service composition and flow section may identify which services are choreographed together to form a composite service. Service composition can be used to support stateless and stateful processes. Stateless processes (micro-flow) are short running and non-interruptible. Stateful processes (macro-flow) are long running and interruptible. Each composition can be named so that it can be referred to in the State Management Decisions section. FIG. 20 is a service flow diagram in an example embodiment of the invention. A process model from WBM or a UML activity diagram can be used to illustrate the flow between services, such as shown in FIG. 20. If an industry model like IFW has been used to identify services, the service flow diagram may be sourced from IFW. A service composition table can be used to define services. The fields in the table may include service name, composition type (whether the service is stateful or stateless), and composition name.

Service Non-functional requirements. Non-functional requirements that can be detailed in the Service Specification include: availability (e.g. Mean Time Between Failures (MTBF), Mean Time to Recovery (MTTR)), operational window (is there ever a time when the service is not expected to be used?), response time (how quickly does the service need to respond to a request?), peak throughput (how many requests for the service can arrive per unit of time—e.g., per second, per minute, per hour?), constraints, alarming and logging, policy and regulation, privacy, security (including encryption and authorization), and data quality (including currency, locality of updating, and data retention). These requirements may be detailed in a table format with Non-functional Requirements (NFR) Type and Non-Functional Requirement as columns and the above listed NFR types as rows. If a requirements catalogue is available to the project, the non-functional requirements can be referenced from the catalogue.

Growth Trends & Performance Expectations. If it is anticipated that transaction volumes for service operations are likely to grow, a table can be used to record the expected trends that will need to be recognized when designing the service. This growth trends table may include columns for operation, peak hourly volumes, and daily volumes. Peak hourly volumes may be defined as the number of transactions for a unique transaction type expected in a peak hour.

Business Policies and Rules. This section may only be required if the service implements any business rules. The business may specify certain business policies and rules that are associated with this service, particularly if this is a business service, but also may state IT policies in the case of business effecting items such as security. The idea is that such policies and rules are subject to frequent change and should not be specified within procedural code but should instead be specified in a rules engine such as iLog with appropriate linkages from the component.

These policies and rules may eventually manifest themselves within a component or components that are subordinate to this service. The design for those components may specify the flow and usage of the business policies and rules. Within the service specification, it may be sufficient to state the business intent of the policy or rule.

Policies may be business policies such as prioritization by type of customer or service level agreements (SLA's) by class of customer. Rules can be constraint rules for the operation or structure being considered or derivation rules that allow the inference or computation of certain information based on existing information on hand. If a business rules catalogue is available to the project, the rules can be referenced from the catalogue. Policy and rule information can be put in a business policies and rules table. The table can include columns such as a column for business policy and rule name and another column for business policy and rule description.

Service Operations. The Service Operations List identifies the functions that are performed as part of the service. This section can detail all operations of the different services. Table 3 is a service operations table that record this information. Typical fields in the table, as in Table 3, include: operation name, whether the service is synchronous or asynchronous, communications protocol information, persistence, and communications technology.

TABLE 3

| Operation | Sync/ | Comm. | | Comm. |
|---|---|---|---|---|
| Name | Async | protocol | Persistence | Technology |
| | Synchronous | SOAP/JMS | Non- | Web |
| | | | Persistent | Services |

Operation Messages. This section can identify the messages for each operation and the format of each of the messages. Table 4 is an operation messages table with sample information from an example embodiment of the invention. Typical fields in an operation messages table may include: message name, type, responsible party, element name, and element type.

TABLE 4

| | | | Element | Element |
|---|---|---|---|---|
| Message Name | Type | Responsible | type | name |
| XxxxxRequest | Input | Consumer | | Request |
| XxxxxResponse | Output | Provider | | Response |
| ServiceError | Fault | Provider | | Header |

Message formats may mirror message names in the operation messages table illustrated in Table 4. A message format table can include elements: element/field, description, data type, length, mandatory, and cardinality. Message formats can be defined using a reference to an external report or spreadsheet or by completing a table with the aforementioned elements as columns. If applicable, the service Web Services Description Language (WSDL) and XML Schema Definition (XSD) files can be referenced if they contain all the detail required by service consumers. Possibly cross-field validation business rules may be need be captured so that service consumers can successfully invoke the service. Message formats can include request, response, and fault. A request message format section can detail the messages that Consumers of a service are responsible for populating. A response message format section can detail the messages that Providers of this service are responsible for populating. The fault message format is standard for all operations and will be returned when a Simple Object Access Protocol (SOAP) error occurs.

State Management Decisions. This section may only be required if the state is managed between the invocation of related services. State management decisions describe the state related requirements and how the requirement will be met. Although an individual service is considered stateless, compositions may require that certain information (e.g. state) be managed during the time that the elements of the composition are being invoked. A state management decisions template table may be created with the columns: composition, state requirements, and decision. Composition can be the name of a composition (the composition can be described in the Service Composition section). State requirements may be the state requirements for this composition. Decision may be where and how state management will be accomplished.

Realization Decisions. The realization decision section may document architectural decisions that deal with how the services will be realized, such as buy, build, and subscribe. Nonfunctional requirements may be prominent criteria in many of these decisions. Consideration may be given to whether architecture decisions need to be made for this service with respect to the following areas and then document those decisions. These decisions may be documented in an architectural realization decisions table that may be created with decision point and decision as columns. Areas to document include the messaging standard, how service descriptions will be externalized, how services are exposed (e.g. web services), how messages are formed (e.g., XML, Applicability Statement 2 (AS2), structured field, proprietary), how/where message transformation will be done, how security will be enforced at the level of the service interface, service name space issues, and division of responsibility between ESB and enterprise components.

Create Documentation Plan. SOA Governance for documentation can provide policies on the following areas:

What to document (and what not): The format can be in a Microsoft® Word document. In an SOA governance system that implements the invention, different types of policies could be codified in executable form allowing automated verification of compliance. An example policy may be: “Any service that is new must use the Solution Architecture Template and Service Specification Template and create these documents in full. Modifications to an existing service must create new versions of these documents if the cost of the modification is greater than $50,000.”

Where to document: The corporate library may be a component in the enhanced governance system. Similarly other documentation repositories could be part of the governance system. An example policy may be: “All documentation must be placed in the corporate documentation library. A new folder will be created for each service that has the same name as the service name.”

In what format to document: For non-word templates, this could point to model templates, tool used, standard formats such as BPMN 2.0. An example policy may be: “The templates themselves will be documented in Microsoft® Office 2007. Examples may use any appropriate computer generated tooling.”

In what granularity to document: This could also be called what level of detail to document, including how deep down to go in process and service hierarchies. An example policy may be: “There shall be one current Solution Architecture Template and one current Service Specification Template per service. The documents shall be versioned.”

In what structure to document: An example policy may be: “The documents shall be documented using the template given in the where to document section above.” This section could also include catalogue structures, standardization of types of documentation, etc.

How to incorporate existing, non-standard, documentation: An example policy may be: “Any existing documentation shall be placed as an Appendix and referenced as an attachment to the standardized documentation.”

Who is documenting which parts of the documentation (by role): This may be a very important part of the governance policy. It can assign authority/responsibility. An example policy may be:

“Solution Architecture Template—the Solution Architect for the service will document this template with assistance as defined here: Solution designer—responsible for representing the technical expertise and evaluating the Solution Architecture end to end solution as being feasible. Business analyst—responsible for representing the business client and validates that the solution meets needs of the business and accepts or declines proposed tradeoffs. Architecture executives—provide guidance, reviews output and ensure governance. Infrastructure architect—(if heavy infrastructure in solution) Have provided infrastructure architecture in the Solution Architecture and answer questions as needed. Infrastructure designer—Validate the solution architecture for structural feasibility. Requirements analyst—Review and understand the high-level solution architecture and context of downstream requirements and analyst comments. Data architect—Have provided data architecture in the Solution Architecture and answer questions as needed. Service Specification Template—the Service Designer for the service will document this template completely.”

How documentation is governed: This section may call out authority, governance decision points, and governance policy enforcement points. An example policy may be: “Documentation will be governed as part of the overall SOA Governance process. In the case of the Solution Architecture Template, it must be reviewed as part of the Solution Architecture Control Gate and be approved by the Business Analysts Leader and the Service Design Leader. In the case of the Service Specification Template, it must be reviewed as part of the Service Design Control Gate and be approved by the Solution Architect and the Service Realization Lead.”

How documentation is maintained (and for how long): This section can also discuss configuration management and who is responsible for maintenance. An example policy may be: “Documentation is versioned. The current version shall be available via the documentation library web browser. Previous versions shall be maintained in the documentation library for a period of 1 year and then be archived. It is required that statistics be kept on the quality and usability of the Solution Architecture Template and the Service Specification Template. These statistics will specifically be measured: 1. Percentage of documentation that is accepted at the first review, second review, third review, and four or more reviews. A preponderance of documentation accepted at the first or second review would indicate that the authors are creating thorough and useful documentation of a high quality. 2. The number and quality of the SOA modeling tool captures for a particular document shall be monitored and assessed. The modeling tools are helpful at each stage of the SOA governance lifecycle and shall be used to derive a continuous quality index of the documentation. 3. Once a month, such statistics will be reviewed in depth by the Architecture Review Board and used to make any mid course correction necessary to the documentation process.”

Assess Documentation plan. In this sub-section, the documentation plan may be checked to see whether it is adequate to support the documentation needs and policies of the enterprise. This may include whether documentation created and maintained according to the documentation plan will be sufficient and adequate for supporting the governance decisions in the enterprise governance processes. Two example policies to assess the documentation plan are: “Service governance decisions are based on reusability value—is the documentation plan sufficient to guarantee that relevant value assessment will be available?” and “Decisions on service SLA's are part of the service governance process—is the documentation plan sufficient to guarantee that operational characteristics are described so that a risk assessment can be made on the risk of not living up to the SLA?”

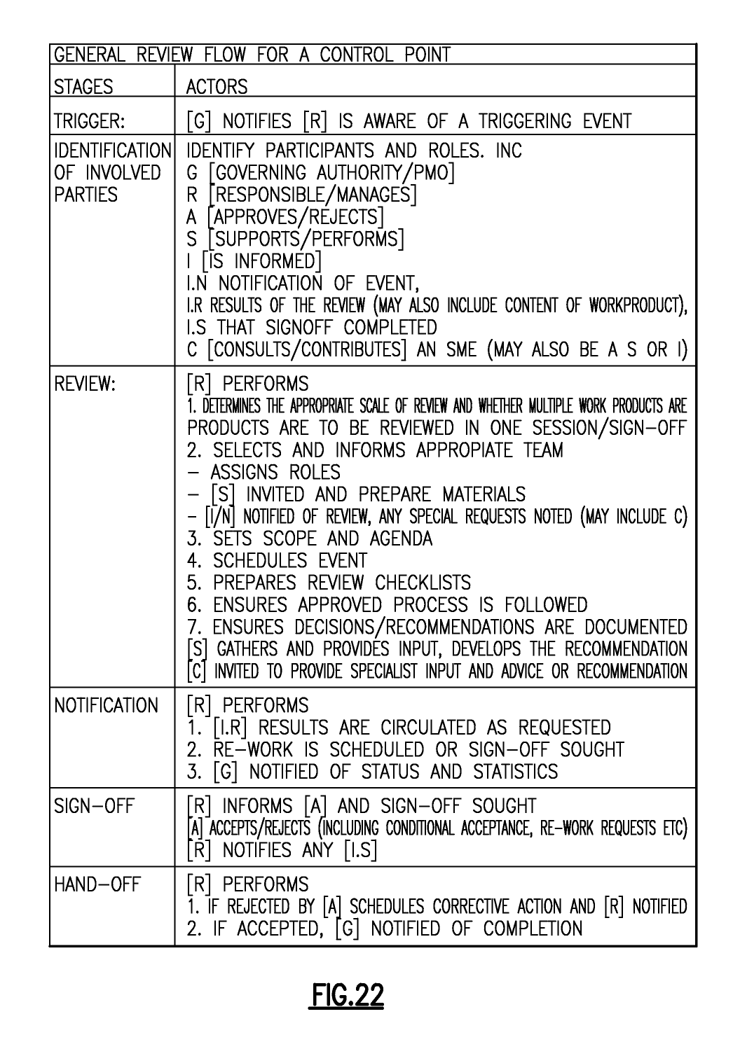

Define measuring and monitoring mechanisms. In this sub-section, measuring and monitoring mechanisms for documentation may be identified. FIG. 21 is a flowchart of the SOA governance lifecycle in an example embodiment of the invention. Sample policies include:

“The documentation will be subject to the SOA Governance lifecycle process. At each control point of the process, documentation artifacts will be identified that must be completed and approved successfully in order to move on to the next governance control point. In the following governance lifecycle, the Solution Architecture document is controlled by the ‘Develop Solution Architecture’ control gate. The Service Specification document is controlled by the ‘Service Specification’ control gate.” This can inject documentation measuring/monitoring mechanisms as an embedded part of SOA governance processes. Note that the documentation plan may be part of the SOA governance system at the same time that it also supports that system by ensuring appropriate quality of documentation.

“Tooling from IBM Rational software shall be used to create the models used in these documents and metrics will be gathered from these models.” This is an example of tools and infrastructure being used to both create and maintain the documentation and report on whether the documentation complies with the documentation plan or not. For instance a service modeling tool can report on whether appropriate templates for service models have been used or not.

“As implied from the SOA Governance Lifecycle, the documentation and their manifestation in the modeling shall be quality assured in the Services Test control gate. Testing shall verify that the solution works as documented in the Solution Architecture and the service performs as documented in the Service Specification template. This verification shall include verification of the service modeling performed in IBM Rational.”

Embed mechanisms in defined governance processes. For example, the following structure has been conceived for the Solution Architecture control gate defined in the SOA Governance process of FIG. 21. The control mechanism in this structure can control for many things, including adequacy of documentation.

SOA Governance Controls Framework. SOA Governance Control gates are described using a standard outline definition. Table 5 is a sample control gate template.

TABLE 5

| Section | Contains |
|---|---|
| Name | Control gate name |
| Motivation | The justification for this control |
| | gate |
| Objective | The output objective in terms of: |
| | (a) the governance or process |
| | objective |
| | (b) the workproduct quality objective |
| | (c) the completion gate objective |
| | (d) the communication objective |
| Trigger | Triggering event |
| Scale/Applicability | Indication of: |
| Guidance | (a) what circumstances will trigger |
| | this review |
| | (b) what scale/style of review is |
| | appropriate for the circumstance |
| Review Type | General classification of review |
| | types: |
| | peer review |
| | submission to approver |
| | workshop |
| | formal meeting |
| | SLA's |
| | Quorum for review |
| Concept/Approach | Description of how the review is |
| | conducted and how it supports the |
| | objective |
| Participants, Roles | G [Governing Authority] |
| and Interests | R [Responsible/Manages] |
| Note 1: roles R, A, | A [Accountable - Approval/Conditional |
| S & C have in | Approval/Rejects] |
| addition a I.n, I.r | C [Consults/Contributes] |
| or I.s role | I [Informed: notified of event, |
| Note 2: all | results, signoff] |
| participants in the | |
| review are by | |
| default I.n and I.s | |
| (informed of the | |
| event and notified | |
| of sign-off) | |
| Note 3: An SME may | |
| also be an S or I | |
| See GRASIC | |
| definition sheet for | |
| more details | |
| Artifacts to be made | Artifact that must be inspected for |
| available | this control gate is required |
| | What opinions must be sought |
| Key review criteria | Highlights the key criteria in terms |
| | of standards, policies, patterns that |
| | the review process must enforce. |
| | Review of the content of the work |
| | product in context of the project |
| | must produce a positive review |
| Key work product | Key acceptance criteria to be met for |
| acceptance criteria | successful review of work product |
| Checklist | Sets a suggested process for the |
| | review. Provides objective support |
| | for recommendations, rework |
| | requests, or sign-off. |
| Escalation Process | Name of escalation process to be used |
| | to request an exception to the |
| | control gate result |
| Measurements | Metrics to be captured during or at |
| | the end of this control gate |
| Outcomes | Generic Notification, |
| | Signoff |
| | Handoff |

SOA Governance Controls Roles. The involved parties in a Control will perform one or more roles. Example role types are described in Table 6.

TABLE 6

| | | |
|---|---|---|
| G | Governing | Governing unit responsible for ensuring |
| | authority | that there is service policy and |
| | | standards to be enforced for this |
| | | governance control gate. Receiver of |
| | | appropriate control gate statistics and |
| | | deliverables so that Governance vitality |
| | | can be tracked and maintained |
| R | Responsible | Responsible for the governance control |
| | for organizing | activity taking place at the right time. |
| | and completing | Sets up the meeting, invites the |
| | the governance | participants, leads the meeting, and |
| | control gate | records the results. |
| A | Accountable - | Individual who is accountable and must |
| | approves the | approve, conditionally approve, or |
| | deliverables | reject the deliverables for this |
| | from the | governance control gate. They must |
| | governance | ensure that the people, time, and money |
| | control gate | are available for the next steps in the |
| | | Service Development Lifecycle. |
| C | Consults on | Individuals who provide consultation on |
| | and supports | the deliverables of this control gate. |
| | the execution | They may be Subject Matter Experts who |
| | of the | provide information about the |
| | governance | deliverables or who challenge whether |
| | control gate | the deliverables are correctly meeting |
| | | service policies and standards. |
| I | Informed about | Individuals or groups who need to be |
| | the status and | informed of the results of the |
| | content of the | governance control gate. |
| | governance | |
| | control gate | |

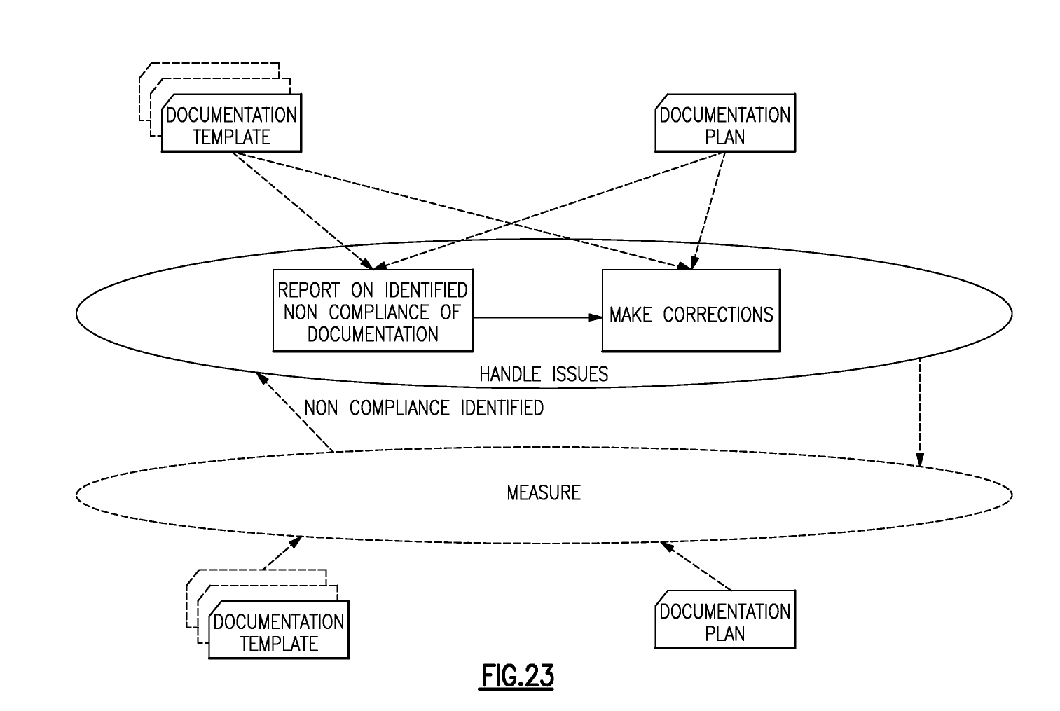

Executing a Control. Each control gate process may be executed in accordance with the scale of the issue under review and the specific objectives of the gate itself. The person responsible for the review can determine the scale of review and notifies the involved parties, supervises the review and manages the sign-off and distribution of results. FIG. 22 is a generic outline for a control review in an example embodiment of the invention.

Conducting a Control Review. Before the event the following activities may be completed: creation/publishing of relevant artifacts; creation publishing of supporting artifacts; discussion with control approver to determine/validate control checklist (i.e. what have they set as the acceptance criteria); assign/approve roles for participants; and schedule control with sufficient time for audience to review content.

During the event the following activities may be considered: validate that participants constitute all roles and have sufficient seniority to approve control; state control objective (and ensure that this is where the time is focused); execute checklist on relevant documents; capture actions and decisions; validate final control outcomes (i.e. approved, conditional approval or rejected); if rework required capture owner of re-work and validate process; and if rejected then capture way forward (i.e. re-execute control or other).

After the event, the following activities may occur as a consequence of control execution: outcomes sheet is updated and issues distributed to all required parties; all involved parties will receive the outcome sheet (refer to Notified of status/signoff); all documents that have been approved will be updated with status; and all rework required will be completed and then forwarded to approvers to review/sign off.

Notified of status/sign off. The communication may contain the following information: control name being executed; name of the Service in review; participants (invited and in attendance); documents referenced in the control (including version numbers); control gate minutes (i.e. key items of discussion, contention); list of action items, including who is responsible and when this is required; and final outcome of the control (either approved, conditional approval based on rework or rejected).

Control Gate Triggers. Control gates may be triggered by events. Triggering events may fall into four broad categories:

1. Where sufficient information now exists or a work product is sufficiently developed to make a review possible. This category may be motivated by a wish to remove any risk at the earliest practical date.

2. When responsibility is being passed from one organization unit to another. Here the primary motivation may be that the receiver of the responsibility wishes to ensure that the work product being transferred is complete and to standard.

3. Where project or progress reporting requires input. The motivation here may be a project check gate or governance policy requirement.

4. If there is benefit from downstream or other communication. This trigger may stem from a wish to get maximum overlap of activity and to provide the earliest possible warning to downstream resource providers.

Control Documents. A primary source of Control Gate triggering may be the development status of key SOA development documents. These documents can be a good reflection of the progress of development decisions and information gathering and as such, provide both the trigger and much of the subject matter for review. These documents may are referred to as Control Documents and are artifacts such as a Solution Architecture, a Services Model, a Design Specification, and a Test Summary Report.

Control documents may mature through the development life-cycle. The level of maturity of a control document may be an indicator of whether a review using the content will be fruitful. Control document maturity can be measured by two status indicators. The first being whether the content is at a general level or a specific level and the second being whether the content is a draft, complete, or approved.

Establishing Appropriate Review Level. The style of review (e.g. peer review, round table of SME's, Workshop etc) may be driven by the scope and complexity of the subject of the review. Similarly, the process of the review itself may be driven by the objective of the review. Consequently, there may be no hard and fast rule can be established as to what is an appropriate review level. The person responsible for conducting the review may make a judgment, and this judgment may wish to take into account the following indicators:

1. The triggering event and motivation. In the previous section, four triggering categories were identified: information is now available, responsibility is being transferred, progress reporting is required, and downstream communication.

2. The perceived risk or benefit of work product or decision alignment. In addition to the considerations above, if the person responsible for the review (or any involved party for that matter) believes a risk may exist that warrants a specific focus or particular attendance or process for a review, this can override the considerations of item 1 above.

3. The value of a second (or more) opinion. In certain instances a broader opinion base may be warranted than normal. This in turn may drive towards a workshop style review, whereas a narrow SME requirement may drive towards a peer review.

4. The degree of change in the development since the last review may be largely a practical consideration. Where large change has taken place it can be dangerous to rely on say a distribution of documents and comment type of review. For legacy content, a presentation and round table may be more appropriate.

Overriding the above however may be the requirement by the Governing Body to report progress status and to identify any issues with work product quality or process effectiveness. That is, the person responsible for the review may not have any other reason for a review other that to capture statistics. In this case, a light weight review with this focus becomes mandatory.

Solution Architecture Control Gates. Table 7 is an example solution architecture control gate.

TABLE 7

| Section | Contains | Definition |
|---|---|---|
| Name | Control point name | Solution Architecture |
| | | Control Gate |
| Motivation | The justification for | Approval to proceed with |
| | this checkpoint | Proposed Solutions |
| | | presented in conformance |
| | | to Group Technology |
| | | vision, principles and |
| | | standards; |
| | | To confirm deliverables |
| | | are encompassing and |
| | | “fit for purpose”; |
| | | To promote deliverable |
| | | integration and support; |
| | | and, |
| | | To proactively |
| | | understand impacts prior |
| | | to further investments. |
| Objective | The output objective | To assess deliverable's |
| | in terms of: | impact on members |
| | (a) the governance | domains and resulting |
| | or process objective | consideration; |
| | (b) the work product | To agree to integration, |
| | quality objective | interfaces and support |
| | (c) the completion | of deliverables; |
| | gate objective | To ensure alternative |
| | (d) the communication | approaches and |
| | objective | solutions; and |
| | | To approve new IT |
| | | Solutions presented. |
| Trigger | Triggering event | Project manager receives |
| | | completed Solution |
| | | Architecture document. |
| Scale/ | Indication of: | MUST ALWAYS |
| Applicability | what scale/style of | BE PERFORMED |
| Guidance | review is appropriate | |
| | for the circumstance | |
| Review | General | A workshop to review the |
| Type | classification of | Solution Architecture |
| | review types: | document and |
| | peer review | corresponding |
| | submission to | requirements artifact |
| | approver | and identify that the |
| | workshop | correct level of detail |
| | formal meeting | per the guidelines has |
| | | been specified. The |
| | | following roles are |
| | | needed: |
| | | Application architect |
| | | Process analyst |
| | | Business architecture |
| | | Business analyst |
| | | Requirements analyst |
| | | Solution designer |
| | | Head of Line of Business |
| Concept/ | Description of how | The business analyst |
| Approach | the review is | must validate the |
| | conducted and how it | requirements as meeting |
| | supports the | the standards for |
| | objective | requirements and must |
| | | then trigger the |
| | | business requirement |
| | | review workshop to be |
| | | scheduled and completed. |
| Participants, | G [Governing | Architecture Review |
| Roles and | Authority] | Board (ARB) |
| Interests | R [Responsible/ | Project Manager—Trigger |
| | Manages] | the meeting and provide |
| | | follow up and results |
| | A [Accountable - | Solution |
| | Approves/Conditional | Architect—responsible for |
| | Approval/Rejects] | presenting and answering |
| | | question on the Solution |
| | | Architecture document |
| | C [Consults/ | Solution designer—responsible |
| | Supports/Performs] | for representing the |
| | | technical expertise and |
| | | evaluating the Solution |
| | | Architecture end to end |
| | | solution as being feasible. |
| | | Business analyst—responsible |
| | | for representing the |
| | | business client and |
| | | validates that the solution |
| | | meets needs of the business |
| | | and accepts or declines |
| | | proposed tradeoffs. |
| | | Architecture |
| | | executives—provide |
| | | guidance, reviews output |
| | | and ensure governance. |
| | | Infrastructure architect—(if |
| | | heavy infrastructure in |
| | | solution) Have provided |
| | | infrastructure architecture |
| | | in the Solution Architecture |
| | | and answer questions as |
| | | needed. |
| | | Infrastructure |
| | | designer—Validate the |
| | | solution architecture for |
| | | structural feasibility. |
| | | Requirements analyst—Review |
| | | and understand the high |
| | | level solution architecture |
| | | and context of downstream |
| | | requirements and analyst |
| | | comments. |
| | | Data architect—Have |
| | | provided data architecture |
| | | in the Solution Architecture |
| | | and answer questions as |
| | | needed. |
| | I [Informed] | All participants, COE |
| Artifacts | What input is | HLSA |
| to be made | required | |
| available | What opinions are to | The Solution Designer, |
| | be sought | Architecture Executives, |
| | | Infrastructure designer, |
| | | Requirements analyst |
| | | must validate the HLSA |
| | | as meeting the needs of |
| | | the next steps of the |
| | | development lifecycle. |
| | | That is, they have the |
| | | information they need to |
| | | do a good job and the |
| | | high level design is |
| | | understood. |
| Key review | Highlights the key | The HLSA must comply |
| criteria | criteria in terms of | with Architectural |
| | standards, policies, | standards, policies, and |
| | patterns that the | patterns. |
| | review process must | The HLSA conforms to |
| | enforce. Review of | existing application |
| | the content of the | future views where those |
| | work product in | views exist. |
| | context of the | Does the HLSA highlight |
| | project must produce | key infrastructure |
| | a positive review | impacts and |
| | | requirements? |
| | | Have services been |
| | | identified and |
| | | classified and are at |
| | | the correct level of |
| | | granularity (services |
| | | litmus tests). |
| Key work | Key acceptance | Consistency and |
| product | criteria to be met | completeness of the high |
| acceptance | for successful review | level design must be |
| criteria | of work product | followed. Any |
| | | Inconsistencies and/or |
| | | gaps and/or |
| | | opportunities for |
| | | improvement or rework of |
| | | the high level design |
| | | must be specified. |
| | | Record next steps, work |
| | | assigned and schedule |
| | | agreed. Any follow-up |
| | | agreed. |
| Checklist | Sets a suggested | Follow the HLSA |
| | process for the | checklist |
| | review. Provides | |
| | objective support for | |
| | recommendations, re- | |
| | work requests, or | |
| | sign-off. | |
| Escalation | Name of escalation | Exceptions to demands |
| Process | process to be used to | for rework can be |
| | request an exception | approved by the |
| | to the control gate | Architecture Review |
| | result | Board. Where the issue |
| | | is a dispute on service |
| | | identification, the ARB |
| | | shall send that issue to |
| | | the COE for resolution. |
| Measurements | Metrics to be | Governance metrics on |
| | captured during or at | this gate including |
| | the end of this | incrementing the number |
| | control gate | of times this gate has |
| | | been implemented, |
| | | incrementing the number |
| | | of times this lead |
| | | architect has been |
| | | through this gate, and |
| | | the results (pass, fail, |
| | | pass with conditions), |
| | | and the checklist score |
| Outcomes | Generic Notification | All Informed are |
| | | notified, Service |
| | | Registrar |
| | Signoff | Architecture Review |
| | | Board Chair |
| | Handoff | HLSA document is |
| | | finalized as an asset |
| | | and passed on to those |
| | | on the informed list. |
| | | The PMO will be the |
| | | official owner of the |
| | | asset. |

Handle & Measure Documentation Process. FIG. 23 illustrates the “handle and measure” process for an example embodiment of the invention. Monitoring may occur to see whether processes are operating appropriately and handle any violations of documentation plan policies. Furthermore any corrections needed to bring documentation back in compliance with the documentation plan may be handled.

Once the documentation process has been defined and enabled, handling and measuring the results of the documentation can be performed and appropriate action can be taken when there are failures in that process.

Specifically these activities may be triggered when the executing governance processes, using the monitoring mechanisms from the Define stage, identify a non-compliance issue on documentation produced.

As was described in the definition of the SOA Governance lifecycle and the corresponding control gates, reports may be created when there is non-compliance with documentation review. The documentation may then be corrected and reviewed again in an iterative cycle. As part of this review process, it can be verified that all non-optional sections of the documentation are filled in and understandable. Optional sections of the documentation can become non-optional at the discretion of the reviewer for a particular SOA Governance control gate. This possibly includes any kind of notification or tracking of action items needed to ensure that the right people (responsible for the documentation) are advised of issues and empowered to correct them.

Relevant data may be generated from the documentation review and communicated to the stakeholders, as called for in the SOA Governance control gate via an automated governance notification capability. This can be a manual process based on office documents, it can be automated reports based on modeling tool templates, or any other mechanisms that was defined to assess/monitor/measure the compliance of documentation.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preferred embodiments to the invention has been described, it will be understood that those skilled in the art, both now and in the future, may make various improvements and enhancements which fall within the scope of the claims which follow. Thus, the claims should be construed to maintain the proper protection for the invention first described.

1. A method for maintaining documentation policies in a service oriented architecture (SOA) governance tool, the method comprising:
implementing a structured documentation plan in a SOA governance tool using a computer processor, wherein the structured documentation plan includes a set of documentation types and a set of governance policies for at least one documentation type from the set of documentation types.

2. The method of claim 1, where the structured documentation plan further includes at least one documentation template for the at least one documentation type from the set of documentation types.

3. The method of claim 2, wherein the at least one document template specifies:
a storage location for the documentation type; a document encoding for the documentation type; a list of persons responsible for the documentation type; a set of instructions to version the documentation type; and instructions to govern the documentation type.

4. The method of claim 2, where the at least one documentation template includes specification of industry standards for documenting the at least one documentation type.

5. The method of claim 2, further comprising, verifying a documentation is in compliance with documentation types and governance policies specified in the structured documentation plan by utilizing at least one metric.

6. The method of claim 1, where the step of implementing the structured documentation plan includes:
defining the set of governance policies, the governance policies specifying persons responsible for implementing portions of the documentation plan; and
recording the set of governance policies in the structured documentation plan.

7. The method of claim 1, further comprising, verifying that the structured documentation plan contains documentation types and governance policies that cover all documentation used in SOA governance processes.

8. The method of claim 1, further comprising, monitoring compliance of documentation according to the structured documentation plan.

9. The method of claim 1, further comprising, inserting at least one documentation checkpoint into at least one governance process in the set of governance processes, the documentation checkpoint specifying a required approval to proceed with a service oriented architecture implementation.

10. The method of claim 1, further comprising, adding a quality assurance criterion to an existing quality assurance activity.

11. The method of claim 1, further comprising, identifying documentation gaps, where documentation is not in compliance with the structured documentation plan.

12. The method of claim 1, further comprising, defining one or more compliance measures.

13. The method of claim 12, where the one or more compliance measures each have one or more monitoring mechanisms.

14. The method of claim 13, further comprising:
identifying the set of governance policies that correspond to the one or more monitoring mechanisms; and
updating the set of governance policies to associate the one or more monitoring mechanisms.

15. The method of claim 13, further comprising:
creating a new governance policy that includes the monitoring mechanism; and
integrating the new governance policy into the structured documentation plan.

16. The method of claim 1, further comprising:
identifying, using the structured documentation plan, the at least one documentation type from the set of documentation types that is in non-compliance;
identifying which governance policies from the set of governance policies are not complied with for the at least one documentation type;
identifying at least one party responsible for managing the at least one documentation type from the set of documentation types; and
generating a notification to the at least one party responsible for managing the at least one documentation type from the set of documentation types.

17. A system for maintaining documentation policies in a SOA governance tool, the system comprising:
a processor;
a memory coupled to the processor, the memory having computer readable program code embodied therewith, the computer readable program code configured to implement a structured documentation plan in a SOA governance tool, wherein the structured documentation plan includes a set of documentation types and a set of governance policies for at least one documentation type from the set of documentation types.

18. The system of claim 17, where the computer readable program code is further configured to monitor compliance of documentation according to the structured documentation plan.

19. A computer program product for maintaining documentation policies in a SOA governance tool, the computer program product comprising:
a computer readable storage medium having computer readable program code embodied therewith, the computer readable program code configured to:
implement a structured documentation plan in a SOA governance tool, wherein the structured documentation plan includes a set of documentation types and a set of governance policies for at least one documentation type from the set of documentation types.

20. The computer program product of claim 19, the computer readable program code further configured to monitor compliance of documentation according to the structured documentation plan.
